(19) United States
(12) Patent Application Publication
(10) Pub. No.: US 2026/0264304 A1
(43) Pub. Date: Sep. 10, 2026

(54) Method and apparatus for obtaining doses for forming an annular seal

(71) Applicant: SACMI COOPERATIVA MECCANICI IMOLA SOCIETA’ COOPERATIVA, Imola (BO) (IT)

(72) Inventors: Carlo VENTURI, Imola (BO) (IT); Riccardo PIANCASTELLI, Imola (BO) (IT); Francesco MINGAZZINI, Imola (BO) (IT); Fabrizio VILLA, Imola (BO) (IT); Piero MARETTI, Imola (BO) (IT)

(21) Appl. No.: 19/472,088

(22) PCT Filed: Apr. 3, 2024
(86) PCT No.: PCT/IB2024/053226

§ 371 Date: Oct. 3, 2025

(30) Foreign Application Priority Data
Apr. 3, 2023 (IT) 102023000006504

(51) Int. Cl. B29C 48/325; B29C 48/13; B29C 48/345; B29L 31/26

(52) U.S. Cl. CPC B29C 48/325; B29C 48/13; B29C 48/345; B29L 2031/26

(57) ABSTRACT

apparatus and a method for obtaining doses intended to form an annular seal in a crown the method comprising the steps of:
supplying a total flow of plastics to an exact N number of extrusion outlets through as many supply channels to obtain a partial flow of extruded plastics exiting from each extrusion outlet, each supply channel being placed in flowing communication with a respective extrusion outlet;
providing for at least N-1 adjustment members, each adjustment member being operatively associated with a respective supply channel;
adjusting each partial flow exiting from each extrusion outlet, said adjusting each partial flow exiting from each extrusion outlet comprising adjusting said at least N-1 adjustment members;
moving a support element that carries N dose separating elements in an advancement direction (A) along a closed loop path so that each dose separating element passes, at each revolution, in front of a respective extrusion outlet;
during said moving and at each revolution of the support element, separating N doses of plastics that are precursors of the annular seal, wherein each of the dose separating elements separates a dose of plastics from an extrusion outlet, said separating being provided after said adjusting each partial flow exiting from each extrusion outlet;
depositing the separate N doses inside a crown cap;
   wherein the N number is equal to three or four or five.

### BACKGROUND OF THE INVENTION

The invention relates to a method and an apparatus for obtaining doses intended to form an annular seal, in particular an inner annular seal (liner) intended to be formed on an inner bottom wall of a crown cap.

In particular, reference is made to a method and to an apparatus for obtaining, by separation from a flow of plastics, several doses of plastics and therefore directly deposit them in a crown cap, so that at least part of the deposited doses has an annular arrangement. As a matter of fact, such annular arrangement will facilitate the formation, in particular by compressing the doses, of the inner annular seal of the crown cap.

A second aspect of the invention relates to a forming apparatus for forming an annular seal on an inner bottom wall of a crown cap, in particular a forming apparatus comprising a cooling circuit through which a cooling fluid flows to maintain the temperature of areas of components intended to form the annular seal low.

### STATE OF THE ART

From the prior art methods and apparatuses are known for obtaining doses for forming an annular seal in caps, in particular caps made of plastics or caps made of metal material of the twist off type, by means of a method comprising separating several doses from an extruder, depositing the doses with a circular arrangement on an inner bottom wall of the cap and form the annular seal by compressing the doses on the inner bottom wall of the cap.

Obtaining an annular seal in caps of the type indicated above is relatively easy, given that such caps have a rather large diameter and, as a result, the width of the circular crown (that is the difference between the outer radius and the inner radius of the two circumferences that define the circular crown) in which the precursor doses of the annular seal are to be deposited is rather high, this allowing to deposit several doses having a maximum base width, in particular a diameter, that is rather large in size.

The European patent EP2739449 B1 on behalf of the Applicant in question discloses a device for separating a relatively high number of doses of plastics to form an annular seal in caps whose size is such to allow to receive, resting in the area intended for forming the seal, several doses, in particular ten doses, having a rather large maximum base width. Such separating device comprises several dose separating elements which, in use, advance towards a corresponding plurality of extrusion outlets from which the plastics exits to separate the doses. Such separating device cannot be immediately transferred into apparatuses for obtaining annular seals in crown caps due to the small dimensions of the crown caps with respect to the types of caps described above and, as a result, the small dimensions of the annular seals which are to be formed in the inner bottom wall of the crown caps, the small dimensions limiting the maximum width of the doses to be deposited. As a matter of fact, apparatuses intended for forming crown caps do not provide for having a number of plastic doses beyond a certain limit (and correspondingly the number of dose separating elements and the number of extrusion outlets) due to some structural restrictions in particular due to the trajectories of the separating elements, the maximum width of a carousel to which the dose separating elements are connected, the maximum width of each dose separating element, the maximum width of each dose, the width of the annular seal intended to be obtained (that is the difference between the outer radius and the inner radius of the two circumferences that define the circular crown).

Other devices for forming a seal in a cap are disclosed by US 2011/0100994 A1 and by U.S. Pat. No. 3,053,221 A.

With reference to FIGS. 1 and 2, furthermore, from the prior art methods and apparatuses are known for forming in a crown cap 1A a seal 2A starting from doses made of plastics, wherein the seal 2A consists of a central panel 3A in form of a solid disc and an edge area 4A. Such methods and apparatuses do not allow to provide crown caps exclusively provided with an annular-shaped seal, that is with a shape in plan view similar to a circular crown.

In addition, such methods and apparatuses for forming a seal comprise a punch 5A suitable to penetrate into the crown cap 1A to shape the doses so as to form the central panel 3A of the seal 2A. The punch 5A comprises an annular central element 6A having a front surface 7A suitable to press at least one dose portion against an inner surface of a bottom wall 8A of the crown cap 1A to form the central panel 3A of the seal 2A. Within the punch 5A there is obtained a cooling circuit 9A through which the cooling fluid coming from an inlet 10A-connected to a cooling fluid supply system-flows. The cooling circuit 9A comprises a central channel 11A substantially coaxial to the longitudinal extension axis of the punch 5A where the cooling fluid flows, in use, downwards, that is towards the front surface 7A and, therefore, towards the crown cap 1A, and an annular outer channel 12A that is obtained externally to the central channel 11A and separated from the latter through an annular wall 13A, where the cooling fluid flows, in use, upwards, that is away from the front surface 7A and, therefore, away from the crown cap 1A. The central channel 11A and the outer channel 12A are in flow communication and, in particular, the central channel 11A terminates in a cooling chamber 14A obtained at an end of the outer groove 12A.

Despite the cooling chamber 14A widens slightly in the radial direction towards the lower part thereof, the cooling fluid, contained therein in use, is not capable of effectively cooling the edge area 4A of the seal 2A.

Therefore, in the light of the above, there is large room for improvement for the apparatuses and methods for obtaining doses for forming an annular seal of the known type and for the forming apparatus for forming an annular seal on an inner bottom wall of a crown cap of the known type.

### OBJECTS OF THE INVENTION

An object of the invention is to improve the methods and the apparatuses for obtaining doses intended to form an annular seal of the known type.

Another object of the invention is to provide a method and an apparatus intended to form an annular seal in a crown cap which allows to obtain an appropriate number of doses to obtain an annular seal in a crown cap and a size of each dose appropriate to be deposited in the area of the bottom wall of the crown cap intended to be occupied by the seal.

An object is to improve the forming apparatuses for forming an annular seal on an inner bottom wall of a crown cap of the known type.

Another object is to provide a forming apparatus for forming an annular seal on an inner bottom wall of a crown cap provided with an effective system for cooling the annular seal.

An advantage lies in providing a method for obtaining doses intended to form an annular seal in which the number of doses obtained is such to allow to obtain the annular seal of pre-established sizes while simultaneously meeting the structural restrictions associated with the components of the apparatus for obtaining doses.

Another advantage lies in providing a method for obtaining doses intended to form an annular seal in which each dose has a size appropriate to be deposited in the area of the bottom wall of the crown cap intended to be occupied by the seal and to prevent an overturning or an inclination of the dose.

A further advantage lies in providing doses having a desired mass.

Still a further advantage lies in providing for doses having a desired shape.

Another advantage lies in providing a forming apparatus with a cooling circuit that allows the cooling fluid circulating therein to reach the areas of the components of the forming apparatus closest to a forming chamber in which the annular seal is formed.

### BRIEF DESCRIPTION OF THE INVENTION

These and other objects and advantages are achieved by the method for obtaining doses for forming an annular seal according to claim 1 and by an apparatus for obtaining doses for forming an annular seal according to claim 14.

In an embodiment, a method for obtaining doses intended to form an annular seal in a crown cap comprises the steps of:
supplying a total flow of plastics to an exact N number of extrusion outlets through as many supply channels to obtain a partial flow of extruded plastics exiting from each extrusion outlet, each supply channel being placed in flowing communication with a respective extrusion outlet;
providing for at least N-1 adjustment members, each adjustment member being operatively associated with a respective supply channel;
adjusting each partial flow exiting from each extrusion outlet, said adjusting each partial flow exiting from each extrusion outlet comprising adjusting said at least N-1 adjustment members;
moving a support element that carries N dose separating elements in an advancement direction along a closed loop path so that each dose separating element passes, at each revolution, in front of a respective extrusion outlet;
during said moving and at each revolution of the support element, separating N doses of plastics that are precursors of the annular seal, wherein each of the dose separating elements separates a dose of plastics from an extrusion outlet, said separating being provided after said adjusting each partial flow exiting from each extrusion outlet;
depositing the separate N doses inside a crown cap;
wherein the N number is equal to three or four or five.

In an embodiment, an apparatus for obtaining doses intended to form an annular seal in a crown cap comprises:
extrusion means of a total flow of plastics comprising an exact N number of extrusion outlets to which said total flow of plastics is supplied to obtain a partial flow of extruded plastics exiting from each extrusion outlet and the same number of supply channels arranged to supply the total flow of plastics to the extrusion outlets, each supply channel being placed in flowing communication with a respective extrusion outlet;
flow adjustment means arranged to adjust each partial flow exiting from each extrusion outlet, the flow adjustment means comprising at least N-1 adjustment members, each adjustment member being operationally associated with a respective supply channel;
dose separating means arranged to separate N doses of plastics that are precursors of said annular seal, the dose separating means comprising:
   a support element that is movable in an advancement direction along a closed loop path arranged so as to pass, at each revolution, in front of a respective extrusion outlet; and
   N dose separating elements fitted to the support element so as to take at least one annular arrangement to enable an ejection of the doses according to a corresponding annular arrangement, each of the N dose separating elements being arranged to separate, at each revolution of the support element, a respective dose of plastics from a respective extrusion outlet;
wherein the N number is equal to three or four or five.

### BRIEF DESCRIPTION OF THE DRAWINGS

The invention will be better understood and implemented with reference to the attached drawings, which show an exemplifying and non-limiting embodiment thereof, wherein:

FIG. 1 is a perspective view of a cross-section of a crown cap with a seal according to the prior art;

FIG. 2 is a cross-sectional view of a forming apparatus for forming a seal of the known type;

FIG. 2A is an enlarged detail of FIG. 2;

FIG. 3 is a perspective view of an apparatus for obtaining doses provided with a plurality of dose separating elements in a first operative position;

FIG. 4 is a perspective view of the plurality of the dose separating elements of FIG. 3 in a second operative position;

FIG. 5 is a perspective view of the plurality of the dose separating elements of FIG. 3 in a third operative position;

FIG. 6 is a perspective view of the plurality of the dose separating elements of FIG. 3 in a fourth operative position;

FIG. 7 is a perspective view of extrusion means of a flow of plastics from which there are obtained doses of plastics with which the apparatus for obtaining doses of FIG. 3 is provided;

FIG. 8 is a view like that of FIG. 7 according to another angle;

FIG. 9 is a lateral view of the extrusion means of FIG. 7;

FIG. 10 is a lateral view like that of FIG. 9 on another side of the extrusion means;

FIG. 11 is a front and transparent view of the extrusion means of FIG. 7 to highlight flow adjustment means of the extruded plastics;

FIG. 12 is a perspective and transparent view of the extrusion means of FIG. 7;

FIG. 13 is a perspective view of the dose separating elements in a dose depositing position;

FIG. 14 is a cross-sectional view of FIG. 13;

FIG. 15 is a perspective view of a crown cap with the doses deposited by the separating elements of FIG. 13;

FIG. 16 is a perspective view like the one FIG. 15 showing—besides the doses—the annular seal which will be formed starting from the deposited doses;

FIG. 17 is a perspective view of the crown cap of FIG. 15 in which the annular seal according to a first embodiment has been formed;

FIG. 18 is a plan view of an arrangement of three doses that are precursor of an annular seal deposited in a circular area on which the annular seal is intended to be formed;

FIG. 19 is a plan view of an arrangement of four doses that are precursor of an annular seal deposited in a circular area on which the annular seal is intended to be formed;

FIG. 20 is a plan view of an arrangement of five doses that are precursor of an annular seal deposited in a circular area on which the annular seal is intended to be formed;

FIG. 21 is a perspective view of a crown cap provided with an annular seal according to a second embodiment;

FIG. 22 is a cross-sectional perspective view of FIG. 21;

FIG. 23 is a cross-sectional perspective view of a seal according to a third embodiment;

FIG. 24 is a cross-sectional view of a forming apparatus for forming an annular seal in a crown cap according to a second aspect of the invention;

FIG. 25 is an enlarged detail of a lower part of FIG. 24;

FIGS. 26 to 31 show operative positions-in succession-of the forming apparatus of FIG. 24;

FIG. 32 is a cross-sectional view of a crown cap with an annular seal obtained by means of the forming apparatus of FIG. 24 after it has been moved to the operative positions of FIGS. 26 to 31;

FIG. 33 is a perspective view of another embodiment of extrusion means of a flow of plastics from which there are obtained doses of plastics with which the apparatus for obtaining doses of FIG. 3 is provided;

FIG. 34 is a perspective and transparent view of the extrusion means of FIG. 33;

FIG. 35 is a top view of the extrusion means of FIG. 33;

FIG. 36 is a section taken along the plane XXXVI-XXXVI of FIG. 35;

FIG. 37 is a section taken along the plane XXXVII-XXXVII of FIG. 35.

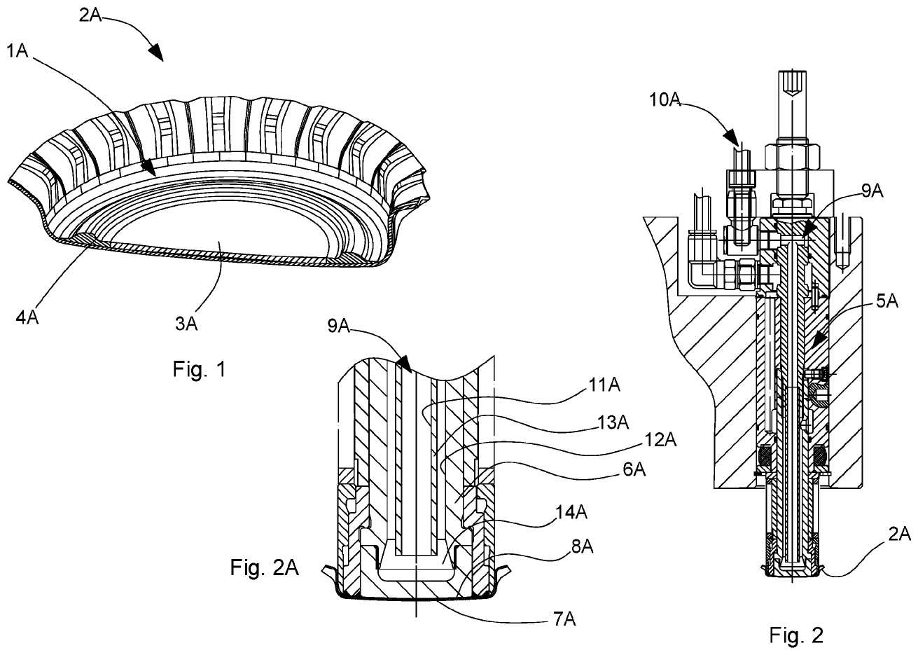

### DETAILED DESCRIPTION OF THE INVENTION

For the sake of simplicity of description, similar elements of different embodiments may be indicated hereinafter using the same reference numerals.

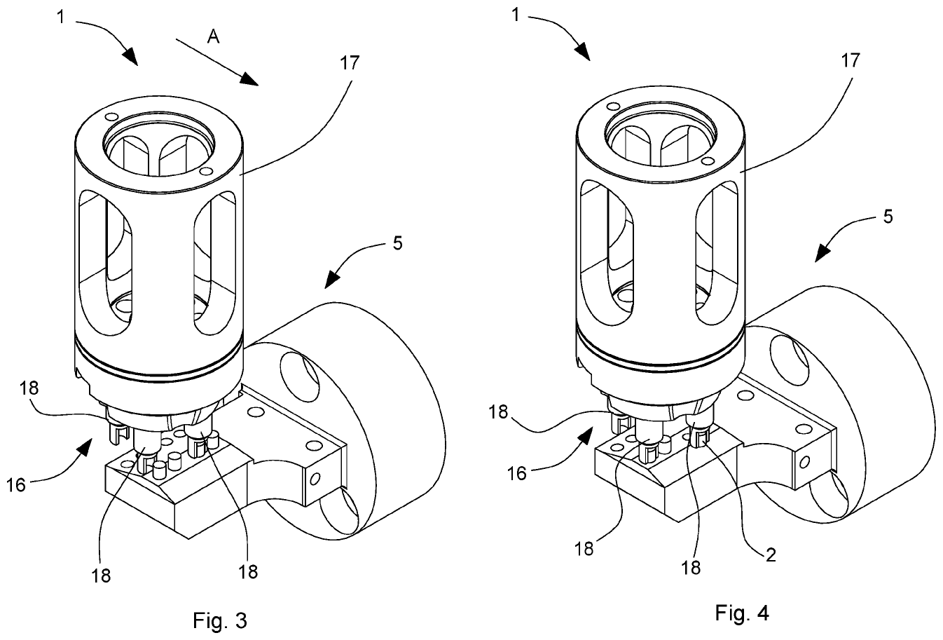

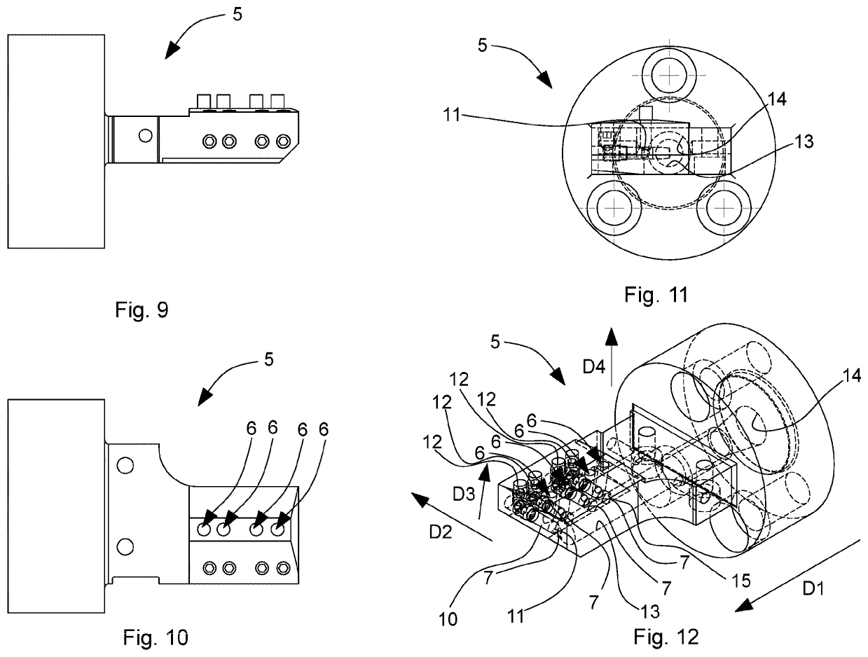

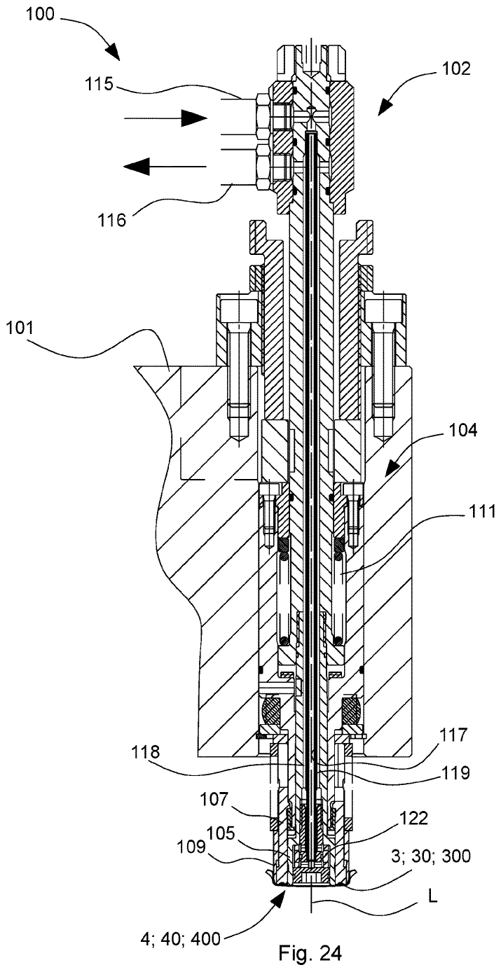

With reference to FIGS. 3 to 14, indicated in its entirety with 1 is an apparatus for obtaining doses 2 of plastics intended to form an annular seal 3 (liner) in a crown cap 4, in particular by compressing, for example, in a forming apparatus 100 according to a second aspect of the invention like the one shown in FIGS. 24 to 31, the forming apparatus 100 being arranged to form an annular seal 3 in a crown cap 4.

With reference in particular to FIGS. 14 to 17, the crown cap 4 comprises a substantially flat end panel 20 having a circular shape in plan view. From a periphery of the end panel 20 there is projected a jacket 21, which can be cylindrical-shaped and from which there extends an edge area 22 which is corrugated and flared outwards.

The annular seal 3 will form the seal in a crown cap 4. In particular, the annular seal 3 is formed on an inner bottom wall 8 of the end panel 20 of the crown cap 4, which is substantially flat.

Opposite to the inner bottom wall 8, the end panel 20 is further provided with an outer wall 28, also for example substantially flat.

In a first embodiment, in particular shown in FIG. 17, the annular seal 3 in particular has a ring shape provided with a pair of substantially flat opposite inner and outer surfaces 23. The outer surface 23 is for example shown in FIG. 17.

The apparatus 1 comprises extrusion means 5 of a total flow of plastics comprising an exact N number of extrusion outlets 6 to which there is supplied the total flow of plastics for obtaining a partial flow of extruded plastics exiting from each of the extrusion outlets 6.

Each extrusion outlet 6 is arranged, in particular, with a vertical upwards direction of exit of the plastics.

The apparatus 1 for obtaining doses 2 allows to obtain N doses 2 from a corresponding plurality of partial flows of extruded plastics which exit from the extrusion outlets 6 of the extrusion means 5.

The extrusion means 5 further comprise N supply channels 7 arranged to supply the total flow of plastics to the extrusion outlets 6. In particular, each supply channel 7 is placed in flowing communication with a respective extrusion outlet 6.

The apparatus 1 further comprises dose separating means 16 arranged to separate N doses 2 of plastics from the extrusion means 5.

The doses 2 are precursors of the annular seal 3. As a matter of fact, when the plastics is deposited on the inner bottom wall 8 of the crown cap 4 they form a precursor of the seal, said precursor being annular-shaped.

The dose separating means 16 comprises a support element 17 that is movable in an advancement direction A along a closed loop path so as to pass, at each revolution, in front of a respective extrusion outlet 6 of the extrusion means 5.

In the specific case, the support element 17 may rotate with a vertical rotation axis performing a substantially horizontal circular path.

The dose separating means 16 further comprises N dose separating means 18 fitted to the support element 17 so as to take at least one annular arrangement so as to allow an ejection of the doses 2 according to a corresponding annular arrangement.

Each of the dose separating elements 18 is arranged to separate, at each revolution of the support element 17, a respective dose 2 of plastic material from a respective extrusion outlet 6.

In particular, the dose separating elements 18 are fitted to the support element 17 and configured so as to separate the doses 2 in succession, that is one dose after the other at each revolution of the support element 17.

Each dose 2 may be substantially cylindrical-shaped.

In an embodiment, the plurality of dose separating elements 18 is fixed to the support element 17 so that they do not move with relative motion with respect to each other.

The N number of extrusion outlets 6 and of dose separating elements 18 is equal to three or four or five to obtain, respectively, three or four or five doses 2 of plastics.

Each dose 2 separated by a respective partial flow of extruded plastics exiting from a respective extrusion outlet 6 has, in particular, a ratio between a maximum dose width D and a dose height H comprised between 0.35 and 1.7.

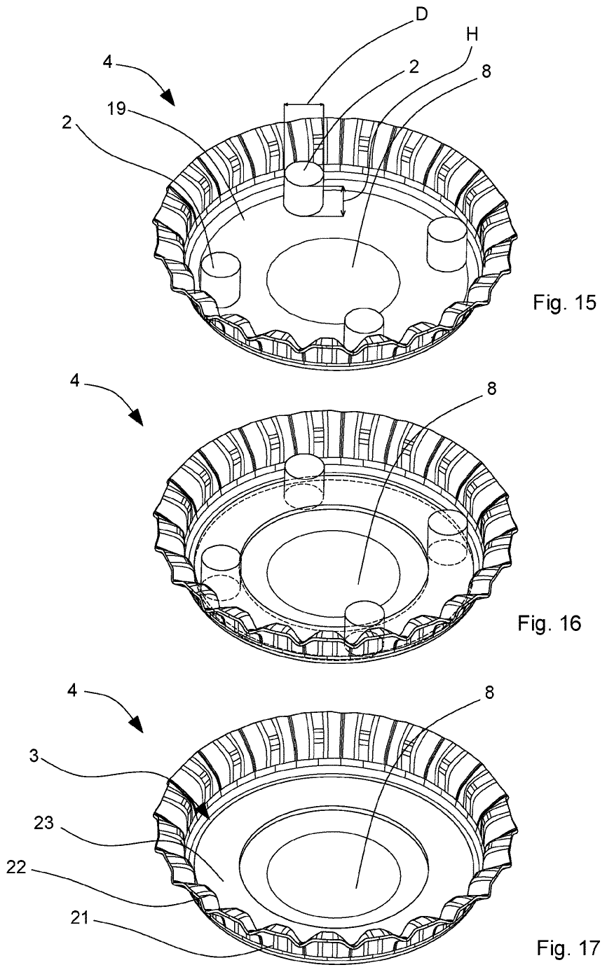

FIG. 15 shows the maximum width D and the height H with reference to a dose 2 deposited on the inner bottom wall 8 of the crown cap 4.

The maximum width D is in particular a diameter of the dose 2 when the dose 2 is substantially cylindrical-shaped.

The size of the maximum width D of each dose 2 is a function of the width of the respective extrusion outlet 6 from which it is extruded.

The ratio between maximum width D and height H of each dose 2 may be, in particular, comprised between 0.75 and 1.7 or between 0.75 and 1.6. Still, such ratio can be, in particular, comprised between 0.75 and 1.5. For example, such ratio may be substantially equal to 1.

Still, such ratio can be, in particular, comprised between 0.75 and 1. Even more particularly and advantageously, such ratio is comprised between 0.35 and 1. For example, the ratio between maximum width D and height H of each dose 2 may be, in particular, comprised between 0.45 and 0.9 or between 0.6 and 0.9 or between 0.6 and 0.8. In this manner, the doses 2 are conveyed more effectively to the forming apparatus 100 and they do not tend to collapse.

The aforementioned ratio between the maximum width D and the height H of each dose 2, in particular when comprised between 0.35 and 1, allows to obtain doses 2 which do not overturn when they are deposited on the inner bottom wall 8 and/or when the crown cap 4 with the doses 2 deposited therein is transferred to a forming apparatus and which, at the same time, do not overflow exceeding an annular area 19 (liner profile) of the inner bottom wall 8 which defines the width of the annular seal 3 which will be formed following the compression moulding of the doses 2 in the forming apparatus, for example the forming apparatus 100.

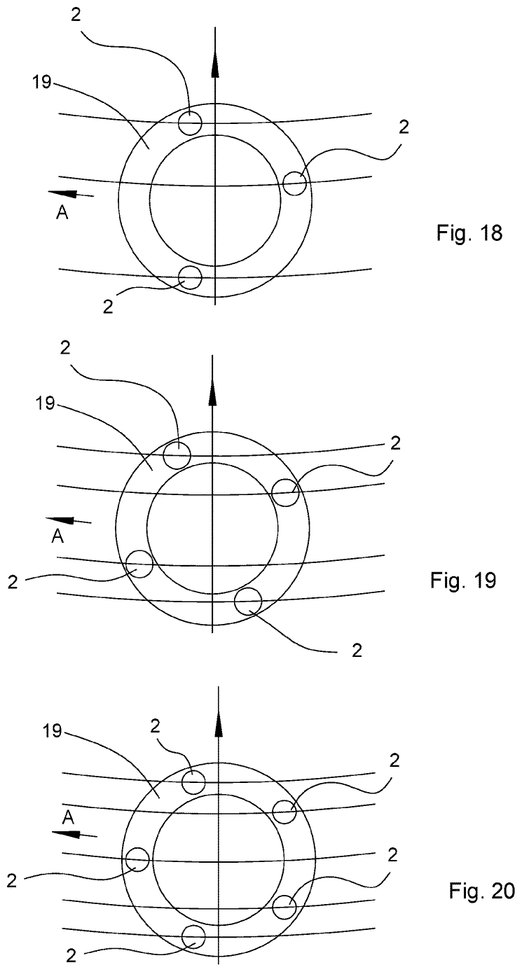

In FIGS. 18 to 20 there is shown an embodiment of such annular area 19 that is substantially circular crown-shaped. Such circular crown may have, in particular, a diameter of the inner circumference, for example, measuring about 16.8 mm and a diameter of the outer diameter, for example, measuring about 24.8 mm. In this case, the maximum width of the dose 2 must be smaller than 4 mm.

The doses 2 may be positioned angularly spaced apart on the annular area 19 as shown, for example, in FIGS. 19 and 20, respectively for providing four doses and for providing five doses.

Alternatively, the doses 2 may be not positioned angularly spaced apart on the annular area 19 as shown, for example, in FIG. 18, for providing three doses.

Furthermore, FIGS. 18, 19 and 20 show—with a dash and dot line—the trajectories of the dose separating elements 18 which—in use—should not overlap.

As a matter of fact, the number of doses 2 (three, four or five) is such to meet the structural restrictions of the apparatus 1 in particular due to the trajectories of the dose separating elements 18, the maximum width of a carousel, not shown, to which the dose separating elements 18 are connected, the maximum width of each dose separating element 18 and the width of the annular seal 3 intended to be obtained (that is the difference between the outer radius and the inner radius of the two circumferences that define the circular crown).

Furthermore, the apparatus 1 for obtaining doses 2 comprises flow adjustment means arranged to adjust each partial flow exiting from each extrusion outlet 6 to obtain the aforementioned ratio between a maximum width D and a height H of each dose 2.

The flow adjustment means comprises at least N-1 adjustment members 10 each of which is operatively associated with a respective supply channel 7 to selectively increase or decrease a passage section for the flow of plastics in the respective supply channel 7. In other words, providing for at least N-1 adjustment members 10 means that a respective adjustment member 10 is operatively associated in at least each supply channel 7 except one.

The flow adjustment means may comprise programmable electronic flow adjustment means configured to vary one or more operating parameters of the extrusion means 5 to vary the total flow of plastics.

Each adjustment member 10 is configured so that it can be adjusted so as to obtain the aforementioned ratio between a maximum width D and a height H of each dose 2 separated from a respective extrusion outlet 6 of a supply channel 7 in which the adjustment member 10 is operatively associated.

Furthermore, each adjustment member 10 is configured so that it can be adjusted so as to obtain a desired flow rate of each partial flow of extruded plastics from each of the extrusion outlets 6 of the supply channels 7 in which a respective adjustment member 10 is operatively associated.

In an embodiment, the flow adjustment means comprises, in particular, N adjustment members 10, each adjustment member 10 being operatively associated with a respective supply channel 7 to selectively increase or decrease a passage section for the partial flow of plastics in the respective supply channel 7.

In another embodiment, the flow adjustment means comprises, in particular, N-1 adjustment members 10, in each supply channel 7 except one there being operatively associated a respective adjustment member 10 to selectively increase or decrease a passage section for the partial flow of plastics in each supply channel 7 except one, and the programmable electronic flow adjustment means being configured to vary one or more of the operating parameters of the extrusion means 5 to vary the flow of plastics in the supply channel 7 devoid of an adjustment member 10.

Each adjustment member 10 is arranged in the flow path of plastics within a respective supply channel 7.

In particular, each adjustment member 10 is at least partially arranged in a respective supply channel 7.

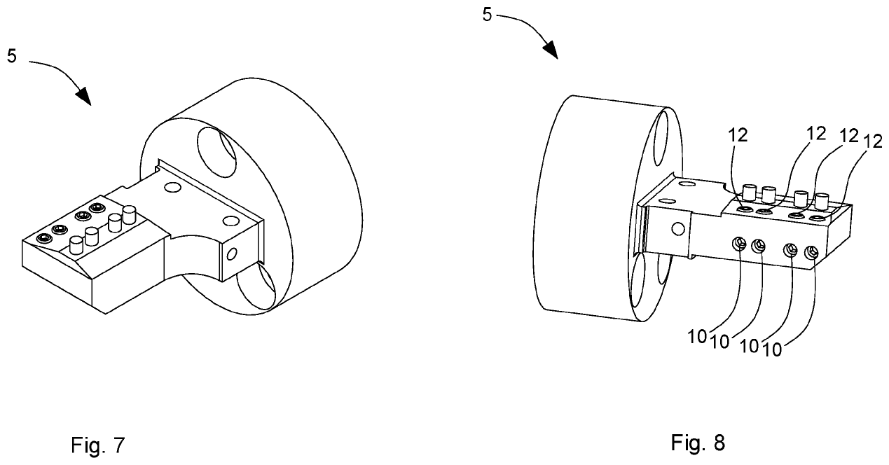

In the version of flow adjustment means shown in the FIGS. 7 to 12, each adjustment member 10 is axially movable within a respective supply channel 7 along a direction substantially parallel to the extension direction of the respective supply channel 7 to vary a position of a respective end 11, in particular tapered, and vary—as a result—a flow rate of each partial flow of plastics in each supply channel 7 or in each supply channel 7 except one.

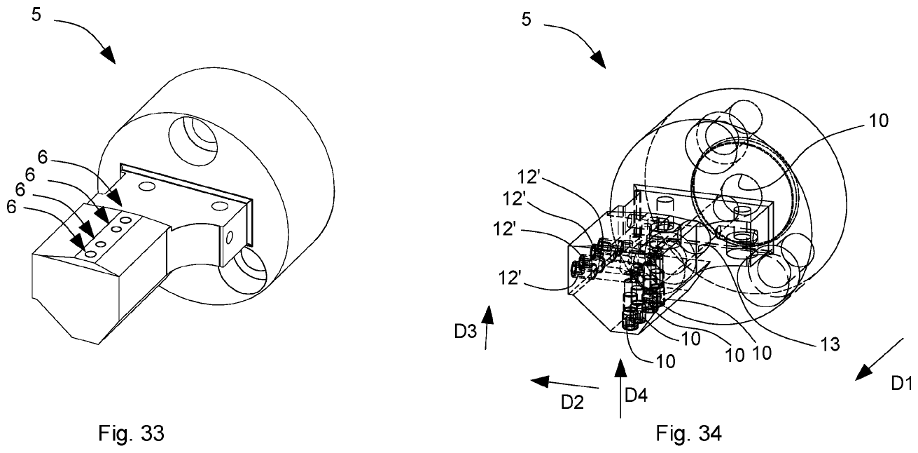

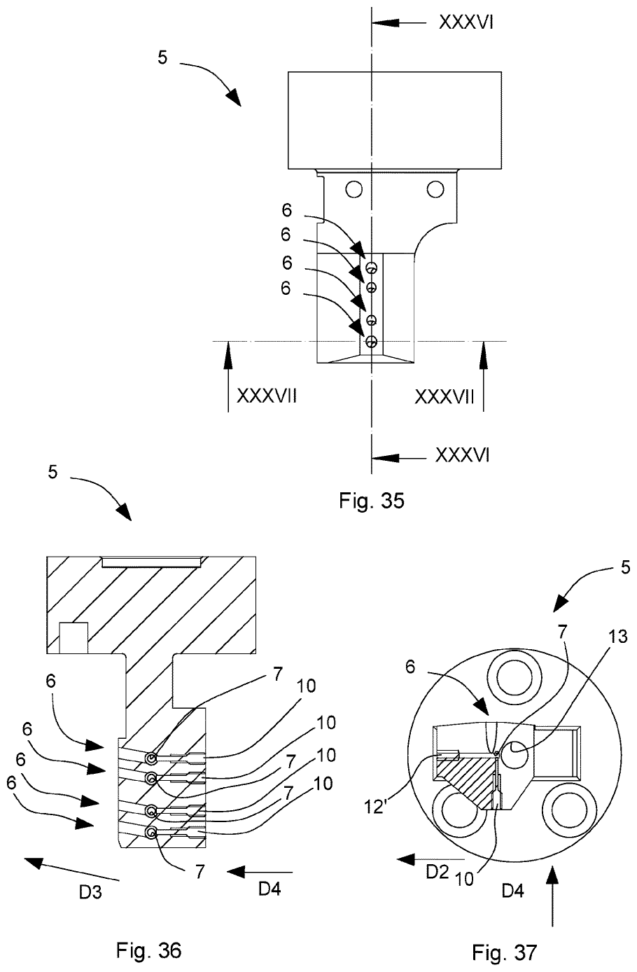

In the version of the flow adjustment means shown in the FIGS. 33 to 37, each adjustment member 10 is axially movable along a direction substantially transversal, in particular perpendicular, to the extension direction of the respective supply channel 7 to vary a position of a respective tapered end 11, in particular tapered, within a respective supply channel 7 and vary—as a result—a flow rate of each partial flow of plastics in each supply channel 7 or in each supply channel 7 except one.

The position of each adjustment member 10 may be varied using actuation means, for example of the manual type. Such actuation means may comprise a screw coupling to allow the axial displacement of the adjustment member 10 in the respective supply channel 7.

In the version shown in FIGS. 7 to 12, the flow adjustment means further comprises a plurality of locking elements 12, each locking element 12 being arranged to interact with a respective adjustment member 10 and lock it in position.

In the version shown in FIGS. 33 to 37 the flow adjustment means further comprises a plurality of closing elements 12′. Each closing element 12′ is arranged in a respective supply channel 7, in particular in proximity of an end thereof, so as to block the passage of plastics outside the flow adjustment means. In other words, each closing element 12′ is configured to sealingly close the respective supply channel 7 in which it is arranged. Each closing element 12′ may comprise, or be, a cap.

The extrusion means 5 may further comprise an extruder, in particular placed in flowing communication with each supply channel 7.

The extrusion means 5 may further comprise a pump, in particular a volumetric pump, arranged downstream of the extruder with respect to a flow direction of the total flow of plastics.

The operating parameters—which can be varied to adjust the total flow of plastics may comprise a velocity of a screw of the extruder or a number of revolutions of a motor of the pump.

The extrusion means 5 may further comprise a delivery conduit 13 at whose end there is obtained an inlet 14 for the total flow of plastics within the extrusion means 5. The delivery conduit 13 is placed in flowing communication with each supply channel 7 by means of a respective opening 15.

In particular, the extruder is placed in flowing communication with the delivery conduit 13 through the inlet 14.

The extrusion outlets 6 may be arranged on the same side with respect to the delivery conduit 13. Therefore, an adjusting operation for adjusting the flow of extruded plastics exiting from the extrusion outlets 6, is facilitated given that the adjustment members 10 can be reached more easily by the actuation means through the extrusion outlets 6 arranged on the same side.

The extrusion outlets 6 may be arranged, in particular, at a greater height with respect to the delivery conduit 13.

Each adjustment member 10 is configured so that it can be adjusted for example depending on the distance between the extrusion outlet 6 corresponding to the supply channel 7 in which an adjustment member 10 is associated, and the inlet 14 of the extrusion means 5 so that each partial flow of extruded plastics exiting from each of the extrusion outlets 6 has a desired flow rate, which can be different as it exits from the various extrusion outlets 6.

The delivery conduit 13 prevalently extends along a direction substantially parallel to a first direction D1, each of the supply channels 7 extends, in particular, prevalently along a respective direction substantially parallel to a second direction D2 substantially parallel to the first direction D1, and each of the extrusion outlets 6 extends, in particular, prevalently along a respective direction substantially parallel to a third direction D3 substantially transversal to the first direction D1 and to the second direction D2.

The second direction D2 is, in particular, perpendicular to the first direction D1.

The second direction D2 may be perpendicular to the third direction D3.

In the version of the flow adjustment means shown in the FIGS. 7 to 12, each adjustment member 10 is arranged with a direction of prevalent development extent substantially parallel to the second direction D2.

In a version, for example the version of the flow adjustment means shown in the FIGS. 7 to 12, the adjustment members 10 are adjusted, that is displaced axially in the respective supply channel 7, along a direction substantially parallel to the second direction D2 and locked in position, so that the flow rate of the partial flows exiting from the extrusion outlets 6 is the same, this so as to obtain doses 2 having substantially the same mass.

In the version of the flow adjustment means shown in FIGS. 7 to 12, each locking element 12 may act, in particular, along a fourth direction D4. The fourth direction D4 is transversal to the first direction D1 and to the second direction D2. In particular, the fourth direction D4 is perpendicular to the first direction D1 and to the second direction D2. The fourth direction D4 may be transversal or parallel to the third direction D3.

In another version, for example the version of the flow adjustment means shown in FIGS. 33 to 37, the adjustment members 10 are adjusted, that is displaced axially along the fourth direction D4 and locked in position, so that the flow rate of the partial flows of extruded plastics exiting from the extrusion outlets 6 is the same, this so as to obtain doses 2 having substantially the same mass.

In the version of the flow adjustment means shown in FIGS. 33 to 34, each adjustment member 10 is arranged with a prevalent development extent substantially parallel to the fourth direction D4.

The direction of exit of the plastics from each of the extrusion outlets 6 is therefore substantially parallel to the third direction D3 and in particular it faces upwards.

The extrusion outlets 6 may be arranged aligned with respect to each other along a direction substantially parallel to the first direction D1. In this case, the extrusion outlets 6 are therefore arranged in a substantially straight arrangement.

Owing to the provision of the supply channels 7, the extrusion outlets 6 and the delivery conduit 13 are staggered along the second direction D2, that is, in other words, the extrusion outlets 6 are displaced laterally with respect to the delivery conduit 13. Therefore, when the adjustment members 10 are adjusted, the flow of plastics in the delivery conduit 13 is not disturbed. This allows to obtain exiting doses having a desired shape.

In an embodiment, owing to the independent adjustment of the partial flows of extruded plastics in the supply channels 7 obtained using the adjustment means, which independent adjustment allows to obtain—exiting from each extrusion outlet 6—a respective partial flow of extruded plastics having a desired flow rate, it is possible to provide for positioning the doses 2 which are not angularly spaced apart, for example as shown in FIG. 18 in case of three doses.

The carousel to which the dose separating elements 18 are connected rotates, for example, around a vertical rotation axis and it can support a plurality of support elements 17 like the ones described above, each of which carries three or four or five respective dose separating elements 18. The support elements 17 may be mounted on the carousel angularly (equally)spaced apart with respect to each other. The carousel may for example comprise a conveyor wheel for conveying crown caps 4 according to a predetermined path, for example circular, along which the doses 2 will be deposited in each crown cap 4.

The crown caps 4 will then be sent to a forming apparatus, for the compression moulding of the doses to obtain the seal/s, for example they will then be sent to the forming apparatus 100 which will be described in greater detail hereinafter.

The apparatus 1 may further comprise a programmable electronic control unit of the known type configured in particular to control the movement of each support element 17, in particular a velocity of each support element 17. The programmable electronic control unit may comprise a programmable electronic controller.

The programmable electronic control unit is configured and/or the flow adjustment means are adjusted so that each dose 2 obtained by a respective partial flow of extruded plastics exiting from a respective extrusion outlet 6 has a determined ratio between a maximum width D and a height H.

As indicated above, such ratio is comprised between 0.35 and 1.7. The ratio between maximum width and height of each dose 2 may be, in particular, comprised between 0.75 and 1.7 or between 0.75 and 1.6. Still, such ratio can be, in particular, comprised between 0.75 and 1.5. Still, such ratio can be, in particular, comprised between 0.75 and 1. Even more particularly and advantageously, such ratio is comprised between 0.35 and 1. For example, the ratio between maximum width D and height H of each dose 2 may be, in particular, comprised between 0.45 and 0.9 or between 0.6 and 0.9 or between 0.6 and 0.8.

With reference to FIGS. 3 to 16 and 19, there is shown an embodiment of an apparatus 1 for obtaining four doses 2 in which the extrusion outlets 6 and the dose separating elements 18 are four, that is the N number is equal to four. In this case, each dose 2 of the four doses 2 may have a height H comprised in a range between 3.8 mm±0.2 mm, in particular a height H of 3.8 mm and a maximum width D, in particular a diameter, comprised in a range between 3.3 mm±0.2 mm, in particular a maximum width D of 3.3 mm.

In another embodiment of apparatus 1 for obtaining five doses 2 which provides for five extrusion outlets 6 and five dose separating elements 18, that is the number N is equal to five, each dose 2 of the five doses 2 separated by the dose separating elements 18 has a height H comprised in a range between 3.3 mm±0.2 mm, in particular a height H of 3.3 mm, and a maximum width D, in particular a diameter, comprised in a range between 2.64 mm±0.2 mm, in particular a maximum width of 2.64 mm.

In still another embodiment of apparatus 1 for obtaining three doses 2 which provides for three extrusion outlets 6 and three dose separating elements 18, that is the N number is equal to three, each dose 2 of the three doses 2 separated by the dose separating elements 18 has a height comprised in a range between 5.06 mm±0.2 mm, in particular a height of 5.06 mm, and a maximum width, in particular a diameter, comprised in a range between 3.3 mm ±0.2 mm, in particular a maximum width of 3.3 mm.

Each of the dose separating elements 18 may be provided with ejection means arranged to eject the dose 2 in an ejection direction, for example vertically downwards.

Each of the dose separating elements 18 may be open—at the lower part-for releasing the dose 2 in a downward (vertical) ejection direction and it may also be shaped with a forward facing concavity, with reference to the advancement direction A. In particular, each of the dose separating elements 18 may have a U-shaped cross-section with the forward facing concavity. However, it is possible to provide for the use of dose separating elements 18 shaped otherwise.

The operation of the apparatus 1 for obtaining doses 2 is clear from the described outlined above.

In the following, the operation of an apparatus for obtaining doses 1 which comprises four extrusion outlets 6 and four dose separating elements 18 in order to obtain four doses 2 will be described in detail, but the operation is similar in the case of an apparatus for obtaining doses 1 which comprises three extrusion outlets 6 and three dose separating elements 18 in order to obtain three doses 2 or five extrusion outlets 6 and five dose separating elements 18 in order to obtain five doses 2.

Each support element 17 rotates carried by the rotary carousel.

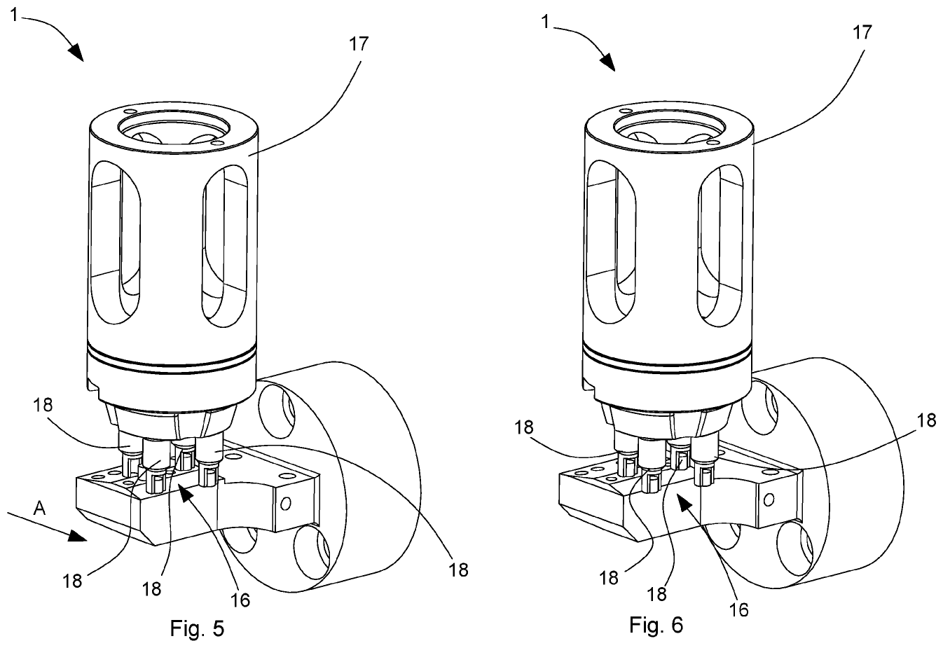

At each revolution of the carousel, while each support element 17 advances in the advancement direction A, in a first time a first dose separating element 18 separates a first dose 2 (FIG. 3), in a second time a second dose separating element 18 separates a second dose 2 (FIG. 4) and in a third time a third dose separating element 18 separates a third dose 2 (FIG. 5).

In the case of four doses 2, subsequently, in a fourth time a fourth dose separating element 18 separates a fourth dose 2 (FIG. 6).

In the case of five doses 2, still subsequently, in a fifth time a fifth dose separating element 18 would separate a fifth dose 2.

After separating the doses 2 from the extrusion outlets 6, each support element 17, advancing in the advancement direction A, is carried above a respective crown cap 4 arranged with cavity facing upwards, that is towards the dose separating elements 18 carried by the support element 17.

The transfer of the doses 2 from the dose separating elements 18 to the inner bottom wall 8 of the crown cap 4 occurs through the relative displacement between the dose separating elements 18 and the crown caps 4 and it is enabled by the fact that the inner bottom wall 8 of the crown cap 4 has an ability to adhere to the molten plastics that form the doses 2 that is greater than that of the dose separating elements 18. For example, appropriate lacquers that enable the doses 2 to adhere to the crown cap 4 may be applied to the inner bottom wall 8. Optionally, the support element 17 and, therefore, the separation elements 18 fixed thereto which retain the corresponding doses 2, are displaced, for example vertically, towards the respective crown cap 4.

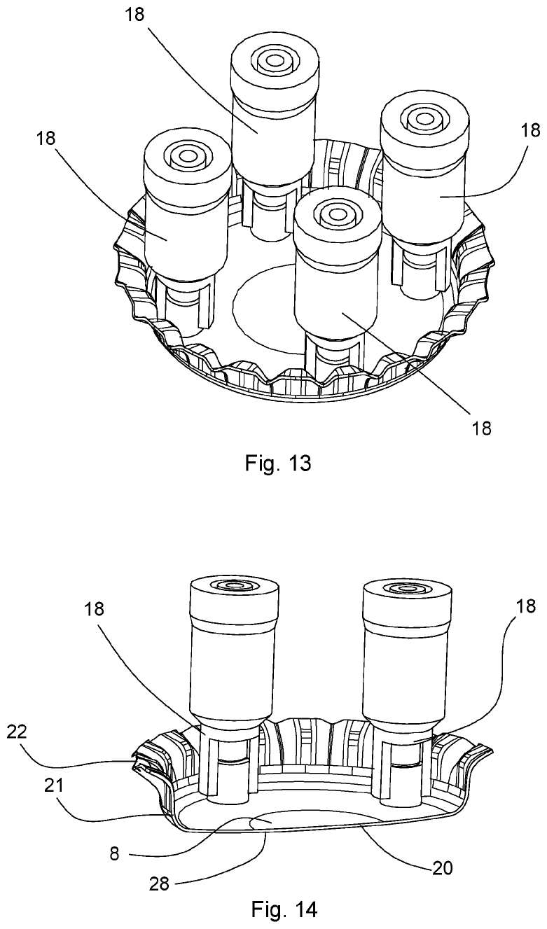

The deposition of the doses 2, with annular arrangement, occurs simultaneously for all four (or three or five) doses 2 (FIGS. 13 and 14), and it can be facilitated by the ejection means which, flowing downwards following a command of an actuation device, push the doses 2 downwards on the support surface, that is the inner bottom wall 8 of the crown cap 4.

During the deposition of the doses 2, the crown caps 4 and the support elements 17 can be moved, respectively along the predetermined path, in particular circular, and along the advancement direction A.

In order for the doses 2 to be deposited correctly in the crown caps 4, the movement of the support elements 17 and of the crown caps 4 is synchronised using the programmable electronic control unit.

Subsequently to the deposition of the doses 2, the crown caps 4 with the doses 2 arranged resting on the annular area 19 of the inner bottom wall 8 (FIG. 15) are sent to a forming apparatus, for example to the forming apparatus 100.

The annular seal may be shaped differently from the shape of the annular seal 3, for example due to the types of crown caps onto which it is to be moulded different from the crown cap 4, although it can be formed starting from three or four or five doses 2 obtained by the apparatus 1 for obtaining doses 2.

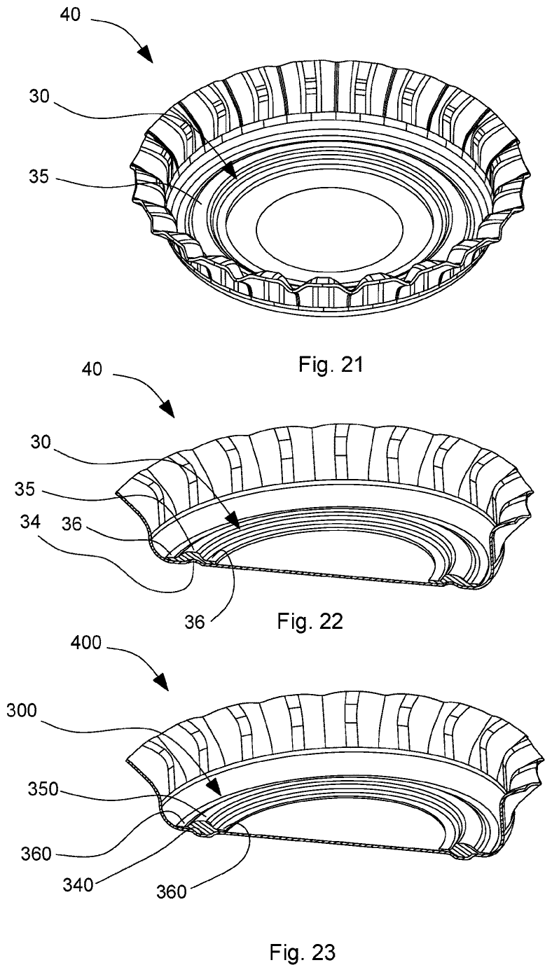

Similarly, the forming apparatus 100 allows the compression moulding of the annular seals 3 on the crown caps 4, but it also allows moulding annular seals shaped differently from the shape of the annular seal 3 on other types of crown caps. Some examples of different shapes of the annular seal and of different types of crown caps are shown in FIGS. 21, 22 and 23.

FIGS. 21 and 22 show a second embodiment of an annular seal 30 moulded on a crown cap 40. An annular groove 34 recessed towards the internal of the crown cap 40 is obtained in the end panel 20 of the crown cap 40. The annular seal 30 comprises a raised area 35 positioned on a portion of the inner bottom wall 8 which is rounded given that it is provided at the annular groove 34. The raised area 35 is flanked by two substantially flat annular edges 36.

FIG. 23 shows a third embodiment of an annular seal 300 moulded on a crown cap 400. A groove 340 which protrudes towards the external of the crown cap 400 and in which the annular seal 300 is at least partially housed, is provided in the end panel 20 of the crown cap 400. Also in this case, the annular seal 300 comprises a central annular protuberance 350 provided on a portion of the inner bottom wall 8 arranged at the groove 340 and flanked by two substantially flat annular edges 360. The thickness of the annular seal 300 measured in the annular protuberance 350 may be significantly greater than the thickness measured in the annular edges 360.

The annular seals 3, 30, 300 produced by the forming apparatus 100 may be moulded starting from a single type of plastics or they may be obtained starting from a compound of different types of plastics or they may have a multilayer structure.

The doses 2 deposited with an annular arrangement may form polymeric annular seals 3, 30, 300 in particular made of low-density polyethylene (LDPE), or linear low-density polyethylene (LLDPE), or ultra low-density polyethylene (ULDPE), or mixtures of similar products, or ethylene vinyl acetate (EVA), or a compound based on polyvinyl chloride (PVC).

Alternatively, in order to obtain the doses 2 there may be used sealant material comprising thermoplastic elastomers and their compounds, for example combinations of polyolefins and copolymers with styrene blocks, combinations of hard polymers and elastomers such as for example polypropylene and ethylene-propylene PP/EPR or polypropylene and ethylene-propylene diene monomer PP/EPDM.

The density of the sealant material (polymer or mixtures) used, in particular, for forming the seal 3, 30, 300, may be comprised between 0.87 and 0.94 g/cm3, in particular between 0.88 and 0.92 g/cm3. The hardness of the sealant material (polymer or mixtures) used, in particular, for forming the seal 3, 30, 300 may be comprised between 40 and 90 Shore A, in particular between 55 and 85 Shore A.

A method for obtaining the doses 2 intended to form an annular seal 3; 30; 300 in a crown cap 4; 40; 400 comprises the step of supplying a total flow of plastics to an exact N number of extrusion outlets 6 through as many supply channels 7 to obtain a partial flow of extruded plastics exiting from each extrusion outlet 6, each supply channel 7 being placed in flowing communication with a respective extrusion outlet 6.

The method for obtaining doses 2 intended to form an annular seal 3; 30; 300 in a crown cap 4; 40; 400 further comprises the step of providing for at least N-1 adjustment members 10, each adjustment member 10 being operatively associated with a respective supply channel 7.

The method for obtaining the doses 2 intended to form an annular seal 3; 30; 300 in a crown cap 4; 40; 400 further comprises the step of adjusting each partial flow exiting from each extrusion outlet 6. Such step for adjusting each partial flow exiting from each extrusion outlet 6 comprises adjusting at least N-1 adjustment members 10.

The method for obtaining the doses 2 intended to form an annular seal 3; 30; 300 in a crown cap 4; 40; 400 further comprises the step of moving a support element 17 which carries N dose separating elements 18 in an advancement direction A along a closed loop path so that each dose separating element 18 passes, at each revolution, in front of a respective extrusion outlet 6.

During the step of moving the support element 17 and at each revolution of the support element 17, the method further comprises the step of separating N doses 2 of plastics that are precursor of the annular seal 3; 30; 300, in which each of the dose separating elements 18 separates a dose 2 of plastics from an extrusion outlet 6.

The step of separating N doses 2 is provided, in particular, after the step of adjusting each partial flow exiting from each extrusion outlet 6.

The method for obtaining the doses 2 intended to form an annular seal 3; 30; 300 in a crown cap 4; 40; 400 further comprises the step of depositing the N doses 2 separated in the crown cap 4; 40; 400, in which the N number is equal to three or four or five.

For each separated dose 2, a ratio between a maximum width D of dose and a height H of dose is comprised, in particular, between 0.35 and 1.7. Such ratio may be, in particular, comprised between 0.75 and 1.7. Each partial flow exiting from each extrusion outlet 6 is adjusted, in particular, through flow adjustment means, to obtain such ratio.

Such ratio may be, in particular, comprised between 0.75 and 1.6. Still, such ratio can be, in particular, comprised between 0.75 and 1.5. Even more particularly, such ratio may be comprised between 0.75 and 1, particularly, and advantageously, it may be comprised between 0.35 and 1. For example, the ratio between maximum width D and height H of each dose 2 may be, in particular, comprised between 0.45 and 0.9 or between 0.6 and 0.9 or between 0.6 and 0.8.

The separating step may comprise obtaining four doses 2 of plastics, each of the four doses 2 having a height H comprised in a range between 3.8 mm±0.2 mm, in particular a height H of 3.8 mm and a maximum width D, in particular a diameter, comprised in a range between 3.3 mm±0.2 mm, in particular a maximum width D of 3.3 mm.

Alternatively, the separating step may comprise obtaining five doses 2 of plastics, each of the five doses 2 having a height H comprised in a range between 3.3 mm±0.2 mm, in particular a height H of 3.3 mm and a maximum width D, in particular a diameter, comprised in a range between 2.64 mm±0.2 mm, in particular a maximum width D of 2.64 mm.

Still alternatively, the separating step may comprise obtaining three doses 2 of plastics, each of the three doses 2 having a height H comprised in a range between 5.06 mm±0.2 mm, in particular a height H of 5.06 mm, and a maximum width D, in particular a diameter, comprised in a range between 3.3 mm±0.2 mm, in particular a maximum width D of 3.3 mm.

The method for obtaining the doses 2 intended to form an annular seal 3; 30; 300 in a crown cap 4; 40; 400 may further comprise the step of adjusting each partial flow exiting from each extrusion outlet 6 to obtain a ratio between the maximum dose width D and a dose height H reported above.

The step of adjusting each partial flow may comprise, in particular, adjusting an adjustment member 10 arranged in each supply channel 7 or varying the total flow and adjusting an adjustment member 10 arranged in each supply channel 7 except one.

The step of adjusting an adjustment member 10 arranged in each supply channel or step of adjusting an adjustment member 10 arranged in each supply channel except one may comprise axially displacing each adjustment member 10 to vary a position of a respective tapered end 11 in a respective supply channel 7 and vary—as a result—a flow rate of each partial flow of plastics in each supply channel 7 or in each supply channel 7 except one.

The axially displacing step may comprise displacing each adjustment member 10 along a direction (D2) substantially parallel to the prevalent extent direction of the respective supply channel 7.

The axially displacing step may comprise displacing each adjustment member 10 along a direction (D4) substantially transversal, in particular perpendicular, to the prevalent extent direction of the respective supply channel 7.

After the axially displacing step, there may be provided for locking each adjustment member 10 in position, for example by means of the respective locking element 12.

The step of varying the total flow may comprise varying one or more operating parameters of the extrusion means 5 of the total flow in order to vary a flow rate of partial flow of (at least) one supply channel 7 devoid of the adjustment member 10.

The step of varying one or more of the operating parameters of the extrusion means 5 may comprise varying a velocity of a screw of an extruder or vary a number of revolutions of a motor of a pump, in particular a volumetric pump, arranged downstream of the extruder with respect to the flow direction of the total flow of the plastics.

The step of adjusting each partial flow exiting from each extrusion outlet 6 may comprise obtaining, exiting from all the extrusion outlets 6, respective partial flows having the same flow rate. This is obtained by adjusting, in particular, the flow adjustment means appropriately.

Alternatively, the step of adjusting each partial flow exiting from each extrusion outlet 6 may comprise obtaining, exiting from all the extrusion outlets 6, respective partial flows having the flow rates that are all not equal. In particular, there may be provided for a different flow rate for one or more of the partial flows for example as a function of the position of the dose 2 obtained by a respective partial flow to be deposited in the annular area 19. Also in this case, this is obtained by adjusting, in particular, the flow adjustment means appropriately.

The step of supplying the total flow of plastics to a plurality of extrusion outlets 6 may comprise supplying the total flow of plastics to the delivery conduit 13 of the extrusion means 5 provided—on the one hand—of the inlet 14 and being placed in flowing communication—by means of respective openings 15—with the supply channels 7. The extrusion outlets 6 may be arranged on the same side with respect to the delivery conduit 13.

The step of supplying the total flow of plastics to a plurality of extrusion outlets 6 may comprise directing the flow of plastics in succession along the first direction D1 corresponding to the prevalent extent direction of the delivery conduit 13, along the second direction D2 substantially transversal to the first direction D1 and substantially transversal to the prevalent extent direction of each supply channel 7 and along a third direction D3 substantially transversal both to the first direction D1 and to the second direction D2.

The direction of exit of the plastics from each of the extrusion outlets 6 may be substantially parallel to the third direction D3 and it may be arranged facing upwards.

The method for obtaining doses 2 intended to form an annular seal 3; 30; 300 in a crown cap 4; 40; 400 may comprise aligning the extrusion outlets 6 along a direction substantially parallel to the first direction D1.

The forming apparatus 100 may comprise a forming carousel 101 comprising a plurality of forming units 102, only one of which is shown in FIGS. 24 to 31.

Each forming unit 102 comprises a support member 103 arranged to support, for example resting thereon, a crown cap 4, 40, 400 in which there were deposited three or four or five doses 2 of plastics forming the precursor of the annular seal 3, 30, 300.

The support member 103 may be driven by an actuator, not shown, in a forming direction F which is substantially vertical in the shown embodiment.

Each forming unit 102 further comprises a punch element 104 arranged to shape the precursor in the crown cap 4, 40, 400 so as to form the annular seal 3, 30, 300.

The punch element 104 of the forming unit 102 extends longitudinally along a longitudinal axis L.

The punch element 104 comprises an inner sleeve 105 having a front surface 106, in particular annular, suitable to abut against the inner bottom wall 8 of the crown cap 4, 40, 400.

The inner sleeve 105 comprises a first sleeve portion 125 and a second sleeve portion 126 connected by a connection portion 127, the first sleeve portion 125 being arranged closest to the support member 103 with respect to the second sleeve portion 126. The first sleeve portion 125 has a longitudinal extension, taken along a direction substantially perpendicular to the longitudinal axis L, greater than that of the second sleeve portion 126. In other words, the first sleeve portion 125 extends radially farthest than the longitudinal axis L with respect to the second sleeve portion 126.

The connection portion 127 defines a sort of step connection between the first sleeve portion 125 and the second sleeve portion 126.

The punch element 104 further comprises an intermediate sleeve 107 arranged outside the inner sleeve 105, that is farthest from the longitudinal axis L with respect to the inner sleeve 105. The intermediate sleeve 107 is delimited by a forming surface 108 having a shape corresponding to the shape of the seal 3, 30, 300 intended to be obtained. In particular, in the shown embodiment, the forming surface 108 coincides with a lower surface of the intermediate sleeve 107.

The punch element 104 further comprises an outer sleeve 109, arranged outside the intermediate sleeve 107, that is farthest from the longitudinal axis L with respect to the intermediate sleeve 107, having an annular end 110 suitable, in use, to abut against the inner bottom wall 8 of the crown cap 4, 40, 400, in particular when the support member 113 is moved along the forming direction F.

The outer sleeve 109 is coaxial to the intermediate sleeve 107.

The inner sleeve 105, the intermediate sleeve 107, the outer sleeve 109 and the inner bottom wall 8 are configured to take an operative configuration in which they define a moulding chamber 112, for example substantially annular-shaped, in particular closed, in which the doses 2 are formed by compression.

The outer sleeve 109 and the inner sleeve 105 peripherally (laterally) delimit the forming chamber 112 (FIG. 28) in which there may be formed the annular seal 3, 30, 300. During the forming, in fact, the inner sleeve 105 obstructs the flow of the compressed molten plastics towards the internal (that is approaching the longitudinal axis L), while the outer sleeve 109 obstructs the flow of the compressed molten plastics towards the external (that is moving away from the longitudinal axis L).

The intermediate sleeve 107 delimits above the moulding chamber 112. In use, the outer sleeve 109 and the inner sleeve 105 are movable with respect to the intermediate sleeve 107 so as to be able to exert a compression action on the doses 2.

The forming unit 102 may further comprise elastic means 111 mounted so that they can act on the inner sleeve 105 so as to push the inner sleeve 105 towards the support member 103. The elastic means 111 may comprise one or more springs.

The forming unit 102 may further comprise a spring element 113 mounted so that it can act on the outer sleeve 109 so as to push the outer sleeve 109 towards the support member 103. The spring element 113 may comprise one or more springs.

The elastic means 111 and the spring element 113, in use, may be at least partially compressed following the movement of the support member 103 along the forming direction F.

The inner sleeve 105, the intermediate sleeve 107 and the outer sleeve 109 are, in particular, mounted in the forming unit 102 so that, when the forming unit 102 is inoperative, that is it is not actuated, the front surface 106 of the inner sleeve 105 protrudes downwards with respect to the forming surface 108 of the intermediate sleeve 107 and the annular end 110 of the outer sleeve 109. In this manner, in use, the front surface 106 of the inner sleeve 105 will the first to be contacted by the crown cap 4, 40, 400.

Still, the inner sleeve 105, the intermediate sleeve 107 and the outer sleeve 109 are, in particular, mounted in the forming unit 102 so that, when the forming unit 102 is inoperative, that is it is not actuated, the forming surface 108 of the intermediate sleeve 107 is in a receded position with respect to the front surface 106 of the inner sleeve 105 and the annular end 110 of the outer sleeve 109 and the latter (annular end 110) is at an intermediate position between the forming surface 108 of the intermediate sleeve 107 and the front surface 106 of the inner sleeve 105.

The forming unit 102 comprises a cooling circuit 114, through which there circulates a cooling fluid coming from an inlet provided for in the forming unit 102 and terminating towards the external of the forming unit 102 from an outlet provided for in the forming unit 102. The inlet of the cooling fluid may be connected, in particular, to an inflow pipe 115 while the outlet of the cooling fluid may be connected, in particular, to an outflow pipe 116.

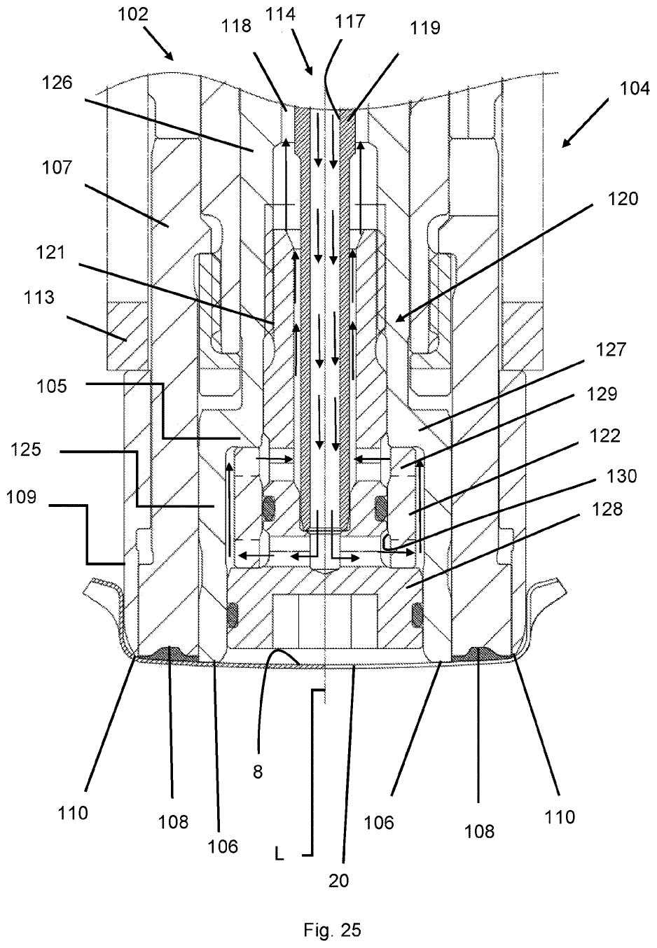

The path and the direction of the cooling fluid in the cooling circuit 114 are represented with arrows in FIG. 25.

In the punch element 104 there is obtained a central chamber 117, which is part of the cooling circuit 114, which extends longitudinally around, in particular coaxially, the longitudinal axis L, such central chamber 117 being placed in flowing communication with the inlet (and therefore with the inflow pipe 115) to receive the cooling fluid which, in use, in the central chamber 117 flow downwards, that is approaching the forming surface 108.

Furthermore, in the punch element 104 there is obtained an annular chamber 118, which is part of the cooling circuit 114, coaxial to the central chamber 117 and separated from the latter by an annular element 119 made of a heat sealing material. The annular chamber 118 is placed in flowing communication with the outlet (and therefore with the outflow pipe 116) for ejecting the cooling fluid from the forming unit 102. In use, in the annular chamber 118 the cooling fluid flows upwards, that is moving away from the support member 103.

The punch element 104 further comprises a central element 120, arranged in the inner sleeve 105, that is closest to the longitudinal axis L with respect to the inner sleeve 105, and connected, in particular fixed, to the inner sleeve 105 so as to be movable along the forming direction F together with the inner sleeve 105.

The central element 120 is arranged in a lower area of the punch element 104.

The central element 120 comprises an annular portion 121 connected to an inner surface portion of the second sleeve portion 126 of the inner sleeve 105. The annular chamber 118 is laterally delimited, in a lower area thereof, by the annular portion 121 and by the sealing annular element 119.

The central element 120 further comprises an enlarged connection element 122 arranged for being crossed by the cooling fluid. The enlarged connection element 122 is placed in flowing communication both with the central chamber 117, from which it receives the cooling fluid, and with the annular chamber 118, in which the cooling fluid exiting from the enlarged connection element 122 flows into. In other words, the enlarged connection element 122 fluidically connects the central chamber 117 and the annular chamber 118 so that the cooling fluid can flow from the central chamber 117 to the annular chamber 118 through the enlarged connection element 122.

The annular portion 121 is connected below, that is towards the support member 103, to the enlarged connection element 122.

The central element 120 further comprises an abutment element 128 connected to the enlarged connection element 122 and arranged to prevent the cooling fluid flowing out downwards from the enlarged connection element 122.

The abutment element 128 and the annular portion 121 are arranged at opposite ends of the central element 120.

In an embodiment, the central element 120 is made of a single piece.

The enlarged connection element 122 is shaped so as to extend radially, that is moving away from the longitudinal axis L, towards the inner sleeve 105, in particular towards the first sleeve portion 125, so that the cooling fluid can come into contact with or in proximity of the regions of the components of the punch element 104 which form the annular seal 3, 30, 300, in particular, in proximity of the first sleeve portion 125 adjacent to the lower end of the intermediate sleeve 107 to maintain them at a low temperature. In fact, after flowing through the central chamber 117 with downward direction, that is towards the support member 103 (or towards the forming surface 108), in the enlarged connection element 122 the cooling fluid flows through a first part of path in radial direction, moving away from the longitudinal axis L, which enables the fluid to reach in proximity of the first sleeve portion 125 as well as in proximity of the abutment element 128, and a second part of path in the enlarged connection element 122 in which the cooling fluid flows upwards, that is moving away from the support member 103 (or from the forming surface 108) substantially next to the first sleeve portion 125. In particular, the enlarged connection element 122 has a longitudinal extension, taken along a direction substantially perpendicular to the longitudinal axis L, greater than that of the annular portion 121. In other words, the enlarged connection element 122 extends radially farthest from the longitudinal axis L with respect to the annular portion 121.

Owing to the enlarged connection element 122, the cooling fluid reaches close to and, therefore, cools the first sleeve portion 125 and, through the latter, by conduction cools the lower end of the intermediate sleeve 107 which is in direct contact with the annular seal 3, 30, 300 during the step of compression moulding. The cooling fluid directly cools—by conduction—a part of the first sleeve portion 125, in particular the part closest to the connection portion 127, while it cools a second part of the first sleeve portion 125, in particular the part farthest from the connection portion 127 and closest to the front surface 106 of the inner sleeve 105, by conduction by means of the abutment element 128.

Subsequently, the cooling fluid flows through a third part of path in the enlarged connection element 122 towards the longitudinal axis L, and then flows into the annular chamber 118 from which it flows towards an outlet of the cooling circuit 114 to which the outflow pipe 116 is connected.

The enlarged connection element 122 is provided with a body 129 which is substantially cylindrical-shaped, in which there is obtained a plurality of passage openings 130, for example arranged circumferentially, for the passage of the cooling fluid.

Owing to the shape of the central element 120 which houses a portion of the cooling circuit 114 and, in particular, of the enlarged connection element 122, the cooling fluid is brought into contact with or in proximity of the regions of the components of the punch element 104 directly involved in the forming of the annular seal 3, 30, 300. In this manner, once formed, the annular seal 3, 30, 300 cools faster than the seals formed in the forming apparatuses of the prior art, this allowing to increase the production of the annular seals 3, 30, 300 given that the cycle time, that is the time used to obtain the annular seal 3, 30, 300 is decreased. In other words, the forming apparatus 100 has an increased productivity with respect to the forming apparatuses provided to form an annular seal in a crown cap of the prior art.

The operation of the forming apparatus 100 will be described hereinafter.

During the operation, a transfer device, not shown, conveys the crown cap 4, 40, 400, for example from the apparatus 1 for obtaining doses 2, towards a forming unit 102.

As mentioned, the doses 2 were previously deposited on the inner bottom wall 8 with a peripheral annular arrangement around a central area of the inner bottom wall 8 of the crown cap 4, 40, 400.

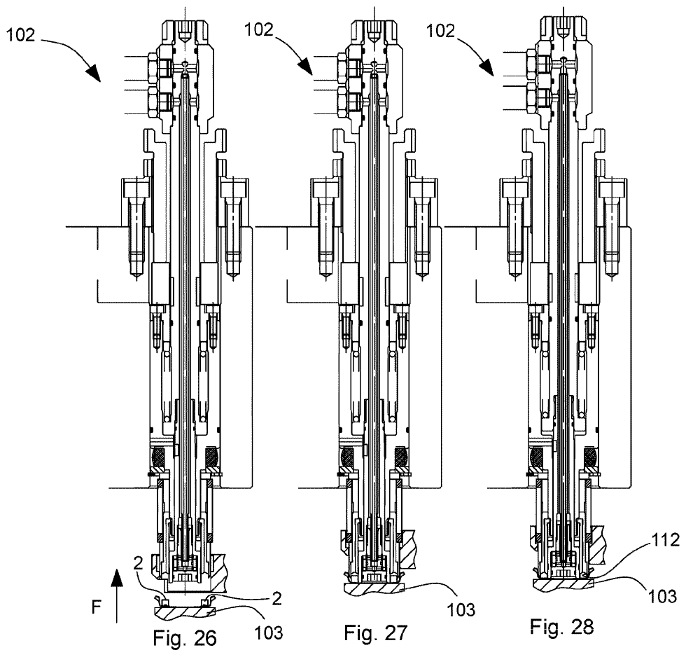

The crown cap 4, 40, 400 is handed over to the support member 103, which was positioned, by the corresponding actuator, in a position spaced apart from the punch element 104. The forming unit 102 is therefore in a first operative configuration (FIG. 26) in which the inner sleeve 105, the intermediate sleeve 107 and the outer sleeve 109 are in a position spaced apart from the support member 103 and from the crown cap 4, 40, 400.

Subsequently, the actuator of the support member 103 nears the crown cap 4, 40, 400 to the punch element 104, in particular moving it upwards along the forming direction F, up to the point in which the front surface 106 of the inner sleeve 105 abuts against a portion of the central area of the inner bottom wall 8 of the crown cap 4, 40, 400. The forming unit 102 therefore reaches a second operative configuration (FIG. 27) in which the inner sleeve 105 contacts the inner bottom wall 8 of the crown cap 4, 40, 400, while the intermediate sleeve 107 and the outer sleeve 109 are in a position spaced apart from the support member 103 and receded with respect to the inner sleeve 105. The inner sleeve 105 of the compression punch element 104 will obstruct, during the moulding of the annular seal 3, 30, 300, the flow of plastics to prevent the plastics from spreading towards the longitudinal axis L.

The support member 103 and, therefore, the crown cap 4, 40, 400, is then further moved along the forming direction F upwards, that is nearing the outer sleeve 109 up to a point in which the annular end 110 abuts against a portion of the inner bottom wall 8 of the crown cap 4, 40, 400, in proximity of a peripheral area of the inner bottom wall 8 of the crown cap 4, 40, 400. The support member 103, in the further movement thereof along the forming direction F, causes a displacement of the inner sleeve 105 along the forming direction F. In the third operative configuration, the elastic means 111 are therefore at least partially compressed. The forming unit 102 therefore reaches a third operative configuration (FIG. 28) in which the inner sleeve 105 and the outer sleeve 109 contact the inner bottom wall 8 of the crown cap 4, 40, 400, while the intermediate sleeve 107 is in a receded position with respect to the inner sleeve 105 and the outer sleeve 109. The outer sleeve 109 of the compression punch element 104 will obstruct, during the moulding of the annular seal 3, 30, 300, the flow of plastics to prevent the plastics from spreading towards the jacket 21 of the crown cap 4, 40, 400. In such configuration, the inner sleeve 105, the intermediate sleeve 107, the outer sleeve 109 and the inner bottom wall 8 of the crown cap 4, 40, 400 cooperate to define the moulding chamber 112 in which the annular seal 3, 30, 300 will be formed.

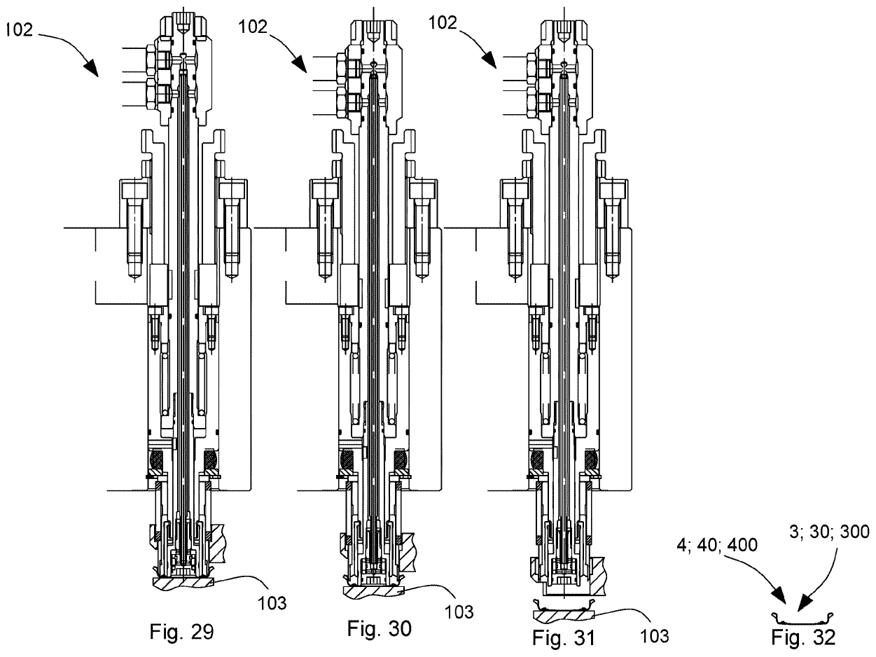

The intermediate sleeve 107 which defines above the moulding chamber 112 compresses the doses 2 at the position for depositing the doses 2 by exerting a compression action on the doses 2 while the support member 103 is moved even further along the forming direction F. Therefore, the forming unit 102 reaches a fourth operative configuration (FIG. 29) in which the inner sleeve 105 and the outer sleeve 109 contact the inner bottom wall 8 of the crown cap 4, 40, 400, and the support member 103 has reached a pre-established end-of-stroke position.

The support member 103 in its even further movement along the forming direction F also causes a displacement of the outer sleeve 109 along the forming direction F. In the fourth operative configuration, both the elastic means 111 and the spring element 113 are therefore at least partially compressed.

In the fourth operative configuration shown in FIG. 29, the inner sleeve 105 and/or the outer sleeve 109 may have reached an end-of-stroke position.

During the moulding of the annular seal 3, 30, 300, the cooling fluid is made to flow in the cooling circuit 114 and, in particular, in succession, in the central chamber 117, in the enlarged connection element 122 and in the annular chamber 118 to cool the plastics which will form the annular seal 3, 30, 300 by cooling the regions of the components of the punch element 104 which cooperate to form the annular seal 3, 30, 300.

Once the annular seal 3, 30, 300 has been formed and its shape stabilised given that it has been sufficiently cooled by means of the cooling fluid, the support member 103 is moved along a direction opposite to the forming direction F moving away from the intermediate sleeve 107 and from the outer sleeve 109 while the inner sleeve 105 is still kept abutting against the inner bottom wall 8 of the crown cap 4, 40, 400 for a given period of time (FIG. 30).

Then, the actuator moves the support member 103 away from the punch element 104 (FIG. 31) and the crown cap 4, 40, 400 can be detached from the punch element 104.

Therefore, the crown cap 4, 40, 400 may be moved away from the support member 103 (FIG. 32), the support member 103 being ready to receive a new cap to be processed.

What has been disclosed and shown in the attached drawings has been provided merely by way of illustrative example of the innovative features of the apparatus 1 for obtaining doses 2 and of the forming apparatus 100.

Variations on and/or additions to what has been disclosed and illustrated in the attached drawings are possible.

1. Method for obtaining doses intended to form an annular seal in a crown cap comprising the steps of:
supplying a total flow of plastics to an exact N number of extrusion outlets through as many supply channels to obtain a partial flow of extruded plastics exiting from each extrusion outlet, each supply channel being placed in flowing communication with a respective extrusion outlet;
providing for at least N-1 adjustment members, each adjustment member being operatively associated with a respective supply channel;
adjusting each partial flow exiting from each extrusion outlet, said adjusting each partial flow exiting from each extrusion outlet comprising adjusting said at least N-1 adjustment members;
moving a support element that carries N dose separating elements in an advancement direction along a closed loop path so that each dose separating element passes, at each revolution, in front of a respective extrusion outlet;
during said moving and at each revolution of said support element, separating N doses of plastics that are precursors of said annular seal, wherein each of said dose separating elements separates a dose of plastics from an extrusion outlet, said separating being provided after said adjusting each partial flow exiting from each extrusion outlet;
depositing said separate N doses inside a crown cap;
wherein the N number is equal to three or four or five.

2. Method according to claim 1, wherein, for each separate dose, a ratio between a maximum dose width and a dose height is comprised between 0.35 and 1.7, each partial flow exiting from each extrusion outlet being adjusted to obtain said ratio.

3. Method according to claim 2, wherein said ratio between said maximum width and said height is comprised between 0.35 and 1, in particular it is comprised between 0.45 and 0.9, even more particularly it is comprised between 0.6 and 0.9, or between 0.6 and 0.8.

4. Method according to claim 2, wherein said separating comprises obtaining three doses of plastics, each of said three doses having a height comprised in a range between 5.06 mm±0.2 mm, and a maximum width, in particular a diameter, comprised in a range between 3.3 mm±0.2 mm, or wherein said separating comprises obtaining four doses of plastics, each of said four doses having a height comprised in a range between 3.8 mm±0.2 mm, and a maximum width, in particular a diameter, comprised in a range between 3.3 mm±0.2 mm, or wherein said separating comprises obtaining five doses of plastics, each of said five doses having a height comprised in a range between 3.3 mm±0.2 mm, and a maximum width, in particular a diameter, comprised in a range between 2.64 mm±0.2 mm.

5. Method according to claim 1, wherein the step of adjusting each partial flow exiting from each extrusion outlet comprises adjusting an adjustment member arranged in each supply channel or varying said total flow and adjusting an adjustment member arranged in each supply channel except one, wherein said adjusting an adjustment member comprises axially moving each adjustment member to vary a position of a respective tapered end and as a result vary a flow rate of each partial flow of plastics in each supply channel or in each supply channel except one, wherein said axially moving comprises moving each adjustment member along a direction substantially parallel to the direction of prevalent extent of the respective supply channel, after said axially moving, there being provided for locking each adjustment member in position by means of a respective locking element.

6. (canceled)

7. Method according to claim 1, wherein the step of adjusting each partial flow exiting from each extrusion outlet comprises adjusting an adjustment member arranged in each supply channel or varying said total flow and adjusting an adjustment member arranged in each supply channel except one, wherein said adjusting an adjustment member comprises axially moving each adjustment member to vary a position of a respective tapered end and as a result vary a flow rate of each partial flow of plastics in each supply channel or in each supply channel except one, wherein said axially moving comprises moving each adjustment member along a direction substantially transversal, in particular perpendicular, to the direction of prevalent extent of the respective supply channel, after said axially moving, there being provided for locking each adjustment member in position using a respective locking element.

8. Method according to claim 1, wherein the step of adjusting each partial flow exiting from each extrusion outlet comprises adjusting an adjustment member arranged in each supply channel or varying said total flow and adjusting an adjustment member arranged in each supply channel except one, wherein said varying said total flow comprises varying one or more operating parameters of extrusion means of said total flow in order to vary a flow rate of a partial flow of a supply channel devoid of said adjustment member, wherein said varying one or more operating parameters of said extrusion means comprises varying a velocity of a screw of an extruder or varying a number of revolutions of a motor of a pump, in particular a volumetric pump, arranged downstream of said extruder with respect to a flow direction of said total flow of plastics.

9. (canceled)

10. Method according to claim 1, wherein said adjusting each partial flow exiting from each extrusion outlet comprises obtaining respective partial flows having the same flow rate exiting from all said extrusion outlets.

11. Method according to claim 1, wherein said supplying said total flow of plastics to a plurality of extrusion outlets comprises supplying said total flow of plastics to a delivery conduit provided on one side with an inlet and being placed in flowing communication by means of respective openings with said supply channels, said extrusion outlets being arranged on the same side as said delivery conduit, wherein said supplying said total flow of plastics to a plurality of extrusion outlets comprises directing said flow of plastics in succession along a first direction corresponding to the direction of prevalent extent of said delivery conduit, along a second direction substantially transversal to the first direction and substantially parallel to the direction of prevalent extent of each supply channel and along a third direction substantially transversal both to said first direction and said second direction, the exit direction of the plastics from each of said extrusion outlets being substantially parallel to said third direction and facing upwards.

12. (canceled)

13. Method according to claim 11, further comprising aligning said extrusion outlets along a direction substantially parallel to the first direction.

14. Apparatus for obtaining doses intended to form an annular seal in a crown cap, wherein said apparatus comprises:
extrusion means of a total flow of plastics comprising an exact N number of extrusion outlets to which said total flow of plastics is supplied to obtain a partial flow of extruded plastics exiting from each extrusion outlet and the same number of supply channels arranged to supply said total flow of plastics to said extrusion outlets each supply channel being placed in flowing communication with a respective extrusion outlet;
flow adjustment means arranged to adjust each partial flow exiting from each extrusion outlet, said flow adjustment means comprising at least N-1 adjustment members, each adjustment member being operationally associated with a respective supply channel;
dose separating means arranged to separate N doses of plastics that are precursors of said annular seal, said dose separating means comprising:
a support element that is movable in an advancement direction along a closed loop path arranged so as to pass, at each revolution, in front of a respective extrusion outlet; and
N dose separating elements fitted to said support element so as to take at least one annular arrangement to enable an ejection of said doses according to a corresponding annular arrangement, each of said N dose separating elements being arranged to separate, at each revolution of said support element, a respective dose of plastics from a respective extrusion outlet;
wherein the N number is equal to three or four or five.

15. Apparatus according to claim 14, wherein, for each separate dose, a ratio between a maximum dose width and a dose height is comprised between 0.35 and 1.7, said flow adjustment means being configured to adjust each partial flow exiting from each extrusion outlet to obtain said ratio, wherein said ratio between said maximum width and said height is comprised between 0,35 and 1, in particular it is comprised between 0,45 and 0.9, even more in particular it is comprised between 0.6 and 0.9, or between 0.6 and 0.8.

16. (canceled)

17. Apparatus according to claim 14, wherein the N number of doses is equal to three and each dose has a height (H) comprised in a range between 5.06 mm±0.2 mm, and a maximum width, in particular a diameter, comprised in a range between 3.3 mm±0.2 mm, or in which the N number of doses is equal to four and each dose has a height comprised in a range between 3.8 mm±0.2 mm, and a maximum width, in particular a diameter, comprised in a range between 3.3 mm±0,2 mm, or in which the N number of doses is equal to five and each dose has a height comprised in a range between 3.3 mm±0.2 mm, and a maximum width, in particular a diameter, comprised in a range between 2.64 mm±0.2 mm.

18. Apparatus according to claim 14, wherein said flow adjustment means comprises:
N adjustment members, each adjustment member being operationally associated with a respective supply channel to selectively increase or decrease a through-flow section of said partial flow of plastics in said respect supply channel; or comprises:
N-1 adjustment members, in each supply channel except one being operationally associated with a respective adjustment member of said N-1 adjustment members to selectively increase or decrease a through-flow section of said partial flow of plastics in each supply channel except one, and
programmable electronic flow adjustment means configured to vary one or more operating parameters of said extrusion means to vary said total flow of plastics.

19. Apparatus according to claim 18, further comprising a programmable electronic control unit configured to control a movement of said support element, said programmable electronic control unit being configured and/or said flow adjusting means being adjustable so that each dose obtained from a respective partial flow of extruded plastics exiting from a respective extrusion outlet has said ratio, wherein each adjustment member is arranged in the path of said partial flow of plastics, each adjustment member being axially movable to vary a position of a respective tapered end and vary as a result a flow rate of each partial flow of plastics in each supply channel or in each supply channel except one, said flow adjustment means further comprising a plurality of locking elements, each locking element being arranged to interact with a respective adjustment member and lock it in position.

20. (canceled)

21. Apparatus according to claim 18, wherein said extrusion means further comprise an extruder placed in flowing communication with each supply channel and a pump arranged downstream of said extruder with respect to a flow direction of said total flow of plastics, wherein said operating parameters comprise a velocity of a screw of said extruder or a number of revolutions of a motor of said pump.

22. Apparatus according to claim 14, wherein said extrusion means further comprise a delivery conduit at whose end there is obtained an inlet for said total flow of plastics and being placed in flowing communication by means of respective openings with each supply channel, said extrusion outlets being arranged on the same side as said delivery conduit.

23. Apparatus according to claim 22, wherein said delivery conduit prevalently extends along a first direction, each of said supply channels prevalently extends along a respective direction substantially parallel to a second direction substantially transversal to said first direction, and each of said extrusion outlets prevalently extends along a respective direction substantially parallel to a third direction substantially transversal to said first direction and to said second direction, the exit direction of the plastics from each of said extrusion outlets facing upwards, and wherein said extrusion outlets are aligned along a direction substantially parallel to the first direction.

24. Apparatus according to claim 23, wherein each adjustment member is arranged in a respective supply channel with a prevalent development extent substantially parallel to said second direction and it is axially movable substantially parallel to said second direction.

25. Apparatus according to claim 23, wherein each adjustment member has a prevalent development extent substantially parallel to a fourth direction substantially transversal to said second direction and it is axially movable substantially transversal to said fourth direction.
